(19) United States
(12) Patent Application Publication
(10) Pub. No.: US 2001/0041474 A1
(43) Pub. Date: Nov. 15, 2001

(54) Respectable for inserting onto the ground outdoors

(76) Inventor: Chao Chuan Chien, Hsin Chuang City (TW)

Correspondence Address: Dougherty & Troxell, ONE SKYLINE PLACE, SUITE 1404, 5205 LEESBURG PIKE, FALLS CHURCH, VA, 22401, US

(21) Appl. No.: 09/876,033

(22) Filed: Jun. 8, 2001

(30) Foreign Application Priority Data
Dec. 29, 1999 (TW) 88222366

(51) Int. Cl. H01R 13/60

(52) U.S. Cl. 439/542

(57) ABSTRACT

A receptacle for inserting on an outdoor ground comprises an insert stick, a socket part, and a power source wire. The insert stick is elongated and the socket part is a shape of box connecting with an end of the insert stick. The socket part provides a plurality of outlets on the upper portion. The power source wire extends outward from the socket part and electrically connecting with circuit components in the outlets.

### BACKGROUND OF THE INVENTION

1. Field of the Invention

The present invention relates to a receptacle for inserting onto the ground outdoors, and particularly to an improvement with regard to a kind of receptacle, which provides an elongated stick to insert into the ground outdoors while in use.

2. Description of Related Art

It is frequent that activities are conducted outdoors and it is not a normal life style that staying indoors all the time. After all, the sunlight, the air, and taking appropriate exercise are required for keeping body health in our human life.

It is known that the progress of civilization has changed our traditional way of work and rest, especially, the daily life of day work and night rest had fronted a serious impact and change since the electricity power was invented. Nowadays, we can conduct activities outdoors at night in addition to being conducted indoors through the utilization of electricity power.

It is really needed to light up the outdoor such as a yard or a garden next to a family house with the electricity power while the gardening job is engaged or an enough illumination has to be offered at night. Thus, a receptacle for inserting onto the ground outdoors was developed for taking the electricity conveniently outside.

The conventional receptacle for inserting onto the ground outdoors provides an insert stick to be stuck in the ground and a plurality of socket outlets are arranged on top of the insert stick for being plugged in case of the electricity being taken. Further, the receptacle has a power source wire for connecting with a socket indoors white in use.

The drawback of the conventional receptacle for inserting onto the ground outdoors resides in that there is no protection from the water for the outlets on the receptacle. For the conventional receptacle exposed outside, it is unavoidable to confront the rainy or snowing days so that the conventional receptacle is usually removed and left inside after use. Definitely, it is very inconveniently for the user while the conventional receptacle is used, and it may result in uselessness in case of the conventional receptacle being not taken back in time.

Moreover, the power source wire provided on the conventional receptacle may not only increase the cost but also leave the ordinary extension line, which is almost equipped in every family house unused. Especially, the extension line with winding drum may be adopted to take the electricity easily. Hence, the power source receptacle attached to the conventional receptacle is redundant.

### SUMMARY OF THE INVENTION

An object of the present invention is to provide a receptacle for inserting onto the ground outdoors, which has a box shaped socket part arranged with outlets at the top thereof and a movable covering pivotally attached above the outlets to prevent from the rain or the water permeating inward.

### BRIEF DESCRIPTION OF THE DRAWINGS

The present invention can be more fully understood by referencing to the following description and accompanying drawings, in which:

FIG. 1 is a perspective view of a receptacle for inserting onto the ground outdoors;

FIG. 2 is a perspective view of a receptacle similar to that shown in FIG. 1 illustrating a covering being added;

FIG. 3 is a perspective view of a further receptacle similar to that shown in FIG. 1 illustrating an external plug being added; and

FIG. 4 is a perspective view of a further receptacle similar to the receptacle shown in FIG. 2 illustrating an external plug being added.

### DETAILED DESCRIPTION OF THE PREFERRED EMBODIMENTS

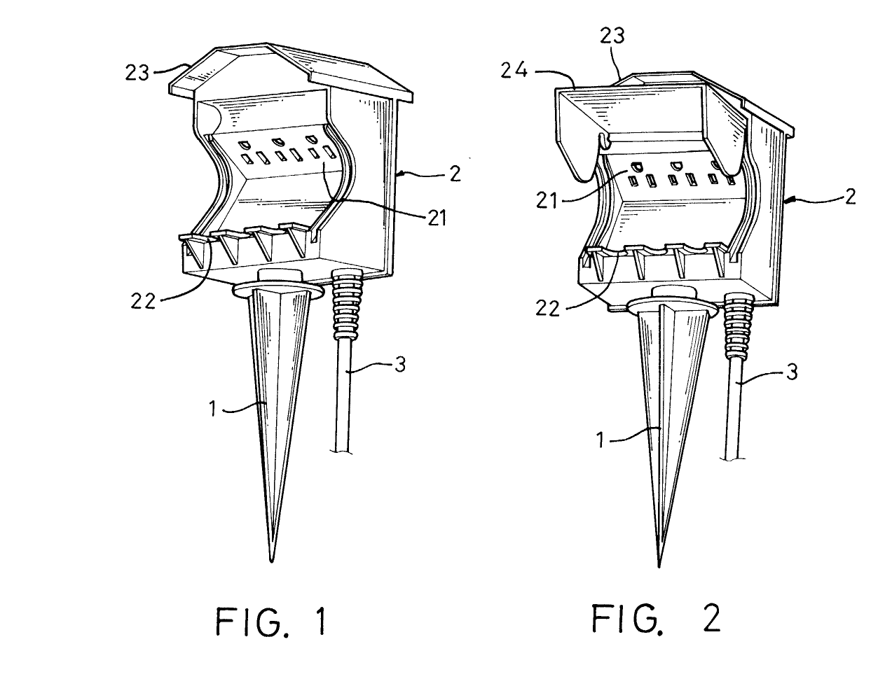

Referring to FIG. 1, the receptacle for inserting onto the ground outdoors according to the present invention basically comprises an insert stick 1, a socket part 2, and a power source wire 3.

Wherein, the insert stick 1 has a shape of elongated sharp cone and the power source wire 3 extends outward from the socket part 2 for externally connecting with a power source. The socket part 2 provides outlets 21 to connect with the power source wire 3 so that the current can be taken. Because the outlets 21 of the socket part are conventional art, no detail will be described further.

The socket part 2 basically provides a shape of partly closed box and the outlets 21 thereof is disposed at the top thereof instead of being disposed at the upright side thereof as the conventional spectacle does. Preferably, the top of the socket part 2 may be arranged to provide a proper slope for being favorable for inserting a plug. The lower edge of the socket part 2 provides a plurality of recesses 22 for being able to be passed through by the power source wire 3. The upper end of the socket part 2 may provide a protruding edge beyond the outlets 21 for keeping out rain.

Referring to FIG. 2, in order to prevent the rain from permeating inward, a movable covering 24 may be disposed in front of the socket part 2 in a way of being pivotally attached to the socket part 2 such that the movable covering 24 can be turned to open or close handily. It is noted that other equivalent ways can be used for the engagement of the movable covering 24 instead of the preceding way of being pivotally attached.

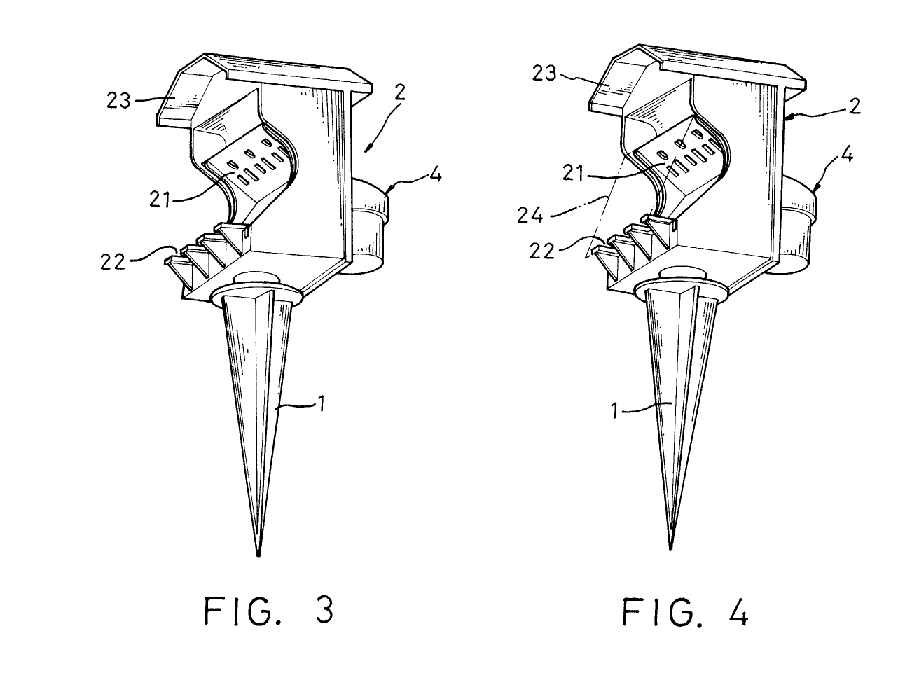

Referring to FIG. 3, the socket part 2 at the rear side thereof provides a power source connector 4 for being able to engage with an external plug/a socket in case of an external power source wire being not available, and the power source connector 4 preferably provides a downward facial side to prevent from the downward water. In the mean time, the connector 4 electrically connects with the outlets 21 so that the current can be taken as soon as a plug is inserted into the outlets 21. The receptacle shown in FIG. 4 illustrates a covering 24 is added in front of the socket part 2 for keeping out the water.

It can be understood from the preceding description that the receptacle with an insert stick of the present invention the outlet on the socket part thereof is disposed at the top of the socket part can prevent the rain from entering and the added covering can enhance the effect of keeping out the water. Besides, the external power source connector is provided in the present invention such that there is no need for joining a power source wire. Thus, not only the mobility of the receptacle disclosed in present invention can be promoted but also the spare extension line can be used for taking the current. In addition, it is not necessary to worry about if the receptacle of the present invention will be damaged or ineffective while it is exposed outdoors. Therefore, these features of the present invention are not possible to be reached by the conventional receptacle with an insert stick.

While the invention has been described with reference to preferred embodiments thereof, it is to be understood that modifications or variations may be easily made without departing from the spirit of this invention, which is defined in the appended claims.

What is claimed is:

1. A receptacle for inserting onto the ground outdoors, comprising
an insert stick with an end, being elongated;
a socket part with an upper portion, being a shape of box, connecting with the end of the insert stick, and providing a plurality of outlets on the upper portion; and
a power source wire, extending outward from the socket part, and electrically connecting with circuit components in the outlets.

2. The receptacle according to claim 1, wherein the a movable covering may be added in front of the socket part.

3. The receptacle according to claim 1, wherein the socket part at a lower edge thereof may provide a recess.

4. The receptacle according to claim 1, wherein an top of the socket part extending outward a projection edge.

5. A receptacle for inserting on the ground outdoors, comprising
an insert stick with an end, being elongated;
a socket part, being a shape of box, connecting with the end of the insert stick, and providing a plurality of outlets on the upper portion; and
a power source connector, joining to the socket part, and electrically connecting with circuit components in the outlets.

6. The receptacle according to claim 5, wherein a movable covering may be added in front of the socket part.

7. The receptacle according to claim 5, wherein the socket part at a lower edge thereof may provide a recess.

8. The receptacle according to claim 5, wherein a top of the socket part extending outward a projection edge.

9. The receptacle according to claim 5, wherein the power source connector is partly closed with an opening facing downward.

10. The receptacle according to claim 5, wherein the power source connector is a socket with outlets;

11. The receptacle according to claim 5, wherein the power source connector is a plug.

12. The receptacle according to claim 5, wherein the power source connector is a plug with a socket.

13. The receptacle according to claim 5, wherein the power source connector is disposed outside the socket part.

14. The receptacle according to claim 5, wherein the power source connector is disposed at a rear side of the outlets.
